(19) United States
(12) Patent Application Publication
(10) Pub. No.: US 2026/0080184 A1
(43) Pub. Date: Mar. 19, 2026

(54) MESSAGE PROCESSING USING LANGUAGE MODELS

(71) Applicant: MICROSOFT TECHNOLOGY LICENSING, LLC, Redmond, WA (US)

(72) Inventors: Jonathan Jay CADIZ, Bellevue, WA (US); Garett Yoshiharu SAKAMOTO, Kirkland, WA (US); Kevin Lucas CHIAN, Redmond, WA (US); Matthew WOOD, Sammamish, WA (US); Katherine Mary EVERITT, Seattle, WA (US); Joseph John MARTELLA, III, Redmond, WA (US); Cristina DAESCU, Seattle, WA (US); Paulo Guilherme de Lima FREIRE, São Carlos (BR); Ravi Kumar JAISWAL, Redmond, WA (US); Renato Uriel Gutiérrez SALAS, Zapopan (MX); Chris JUNG, Seattle, WA (US); Lauren Diana LO, Seattle, WA (US)

(21) Appl. No.: 18/964,326

(22) Filed: Nov. 29, 2024

Related U.S. Application Data
(60) Provisional application No. 63/694,787, filed on Sep. 13, 2024.

(51) Int. Cl. G06F 40/40

(52) U.S. Cl. CPC G06F 40/40

(57) ABSTRACT

A representation of an email application includes a message view comprising a plurality of email messages. In response to receiving an indication that a new email message has been received, a prompt is generated for input to a large language model (LLM). The prompt is usable to cause the LLM to analyze content of the new email message and determine a priority of the new email message. The priority is localized to a context based at least in part by a recipient and sender of the new email message.

### CROSS-REFERENCE TO RELATED APPLICATION

This application claims the benefit of US provisional application number 63/694,787 filed on Sep. 13, 2024, entitled “MESSAGE PROCESSING USING LANGUAGE MODELS” the entirety of which is hereby incorporated by reference herein.

### BACKGROUND

Computing systems generally provide interactive and collaborative environments that facilitate communication between users. Such systems may include an email application configured to send and receive electronic messages. Although existing email applications provide features for managing emails, inefficient interaction with email applications can be detrimental to user productivity and use of computing resources. When email applications do not optimize user engagement and information sharing, production loss and inefficiencies can result when a participant is unable to quickly and easily view and digest numerous emails and interact with the message context. It is with respect to these considerations and others that the disclosure made herein is presented

### SUMMARY

Many email applications present message information in a static format. Details of a message may not be provided in a dynamic and time-sensitive manner, and pertinent details may not be readily available unless a message is opened or otherwise accessed. By the use of the technologies described herein, information for a message or a series of related messages is presented in a dynamic format that allows for timely and useful information to be rendered directly within the email application view.

In various embodiments, artificial intelligence (AI) is used to manage, view, and prioritize emails in an inbox. The disclosure includes features such as automatic summarization and prioritization of messages, placement of selected information in the message list view, and personalization of the summarization and prioritization to the user.

In one embodiment, an event-based assistant (EBA) is invoked when an email message is delivered. The EBA sends the email contents to a large language model (LLM) with a prompt for evaluation. The LLM analyzes the email contents and determines a priority of the message based on various factors. The LLM further determines other useful information such as a summary of the contents and potential responsive actions by the user. A priority is assigned to the email and indicated in the message list view. The user can sort the emails in the inbox by priority. The reading pane includes the reason for the priority and the user can provide feedback to improve the email evaluation. The EBA personalizes the prioritization as well as other information by using contextual information for the user from the user's address book, such as titles and organizational positions of the user, sender, and recipients.

Data from a number of resources can be utilized to provide contextually-aware information for the user's messages. The disclosed technologies can improve user interaction with a computing device by automatically generating and displaying timely and relevant information without requiring users to open all of their messages, conduct a search, or manually access a number of resources. Among many benefits provided by the technologies described herein, a user's interaction with a device may be improved, which may reduce the number of inadvertent inputs, reduce the consumption of processing resources, and mitigate the use of network resources. Other technical effects other than those mentioned herein can also be realized from implementations of the technologies disclosed herein. Existing systems for allowing users to manually interact with electronic messages typically require users to perform a number of tasks. The user can spend a considerable amount of time searching through messages to find and respond to messages, invoke additional applications to perform functions that are not native to the email application, and to find content that is associated with a particular message or series of messages. This can lead to extensive and unnecessary consumption of computing resources.

The examples described herein may be provided within the context of collaborative environments, e.g., electronic mail and other types of messages. For illustrative purposes, it can be appreciated that a computer managing an email environment involves any type of computer that can access a user's email data and manage an inbox. For illustrative purposes, an “email” is a digital message exchanged over a network such as the internet. Additionally, while many of the illustrated examples use LLMs, it should be noted that other models can be utilized without limiting the scope of the disclosure.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIGS. 1A-1C are example user interfaces illustrating aspects of an email environment for the embodiments disclosed herein.

FIGS. 2A-2E illustrate example user interfaces, according to embodiments disclosed herein.

FIG. 3 illustrates an example user interface, according to one embodiment disclosed herein.

FIG. 4 illustrates an example user interface, according to one embodiment disclosed herein.

FIG. 5 illustrates an example user interface, according to one embodiment disclosed herein.

FIG. 6 illustrates an example user interface, according to one embodiment disclosed herein.

FIGS. 7A-7B illustrate example user interfaces illustrating aspects of an email environment for the embodiments disclosed herein;

FIG. 8 is an example functional diagram illustrating aspects of prompt generation for the embodiments disclosed herein;

FIG. 9 is a computing system diagram showing aspects of an illustrative operating environment for the technologies disclosed herein;

FIG. 10 is a computing system diagram showing aspects of an illustrative operating environment for the technologies disclosed herein;

FIG. 11 is a computing device diagram showing aspects of the configuration and operation of a device that can implement aspects of the disclosed technologies, according to one embodiment disclosed herein.

FIG. 12 is a computing system diagram showing aspects of an illustrative operating environment for the technologies disclosed herein;

FIG. 13 illustrates aspects of a routine, according to one embodiment disclosed herein;

FIG. 14 illustrates aspects of a routine, according to one embodiment disclosed herein;

FIG. 15 is a computing system diagram showing aspects of an illustrative operating environment for the technologies disclosed herein;

FIG. 16 is a computing device diagram showing aspects of the configuration and operation of a device that can implement aspects of the disclosed technologies, according to one embodiment disclosed herein.

### DETAILED DESCRIPTION

The following Detailed Description describes an improved interface for viewing and interacting with electronic messages that are rendered in an email application. Various embodiments are disclosed that enable productive analysis and management of electronic messages. This can result in more efficient use of computing resources such as processor cycles, memory, network bandwidth, and power, as compared to previous solutions relying upon inefficient interaction with a convention email environment and objects within the rendered inbox. Technical benefits other than those specifically described herein might also be realized through implementations of the disclosed technologies.

Email messages or objects are typically representations of mail messages in an email application that is configured to provide an electronic representation of a mailbox. The representation may include a message having a sender and recipient(s), subject line, message body, and optionally attachments. The email application may be a local application designed for individual use or may be a cloud-based networked application. Examples of email software include GOOGLE GMAIL or MICROSOFT OUTLOOK.

Many email applications present message information in a static format. Relevant information pertaining to a message or a series of messages (i.e., a “conversation”) are not updated in a dynamic and real-time manner and it is entirely up to the user to read through all of the user's messages, prioritize important messages and identify those that require follow-up, and generally understand and keep track of various email conversations and their status. Email content may not be readily available unless the email is opened or otherwise further activated such as in a preview pane.

Various embodiments are disclosed for implementing an improved interface along with analytical tools for viewing and interacting with messages of an email application. By the use of the technologies described herein, information for a user's messages is presented in a dynamic format that allows for timely and useful information to be rendered directly within the message list view. The dynamic view may include real-time updates as to the content of a message or a series of messages, as well as interactive capabilities provided directly on a representation of the message list or in an individual message.

While existing email application user interfaces provide a message list, additional features are only provided when the message is further engaged by the user, such as opening the message, opening and selecting a menu option, or otherwise further moving away from the message list view. In some cases, the user must select a detailed view which requires multiple clicks to open and access details of the message.

Data from a number of resources can be utilized to provide contextually-aware information for electronic messages. Such technologies can improve user interaction with a computing device by automatically generating and displaying timely and relevant information without requiring users to open a message, conduct a search, or manually access a number of resources. Among many benefits provided by the technologies described herein, a user's interaction with a device may be improved, which may reduce the number of inadvertent inputs, reduce the consumption of processing resources, and mitigate the use of network resources. Other technical effects other than those mentioned herein can also be realized from implementations of the technologies disclosed herein.

In some embodiments, AI is used to manage, view, and prioritize emails in an inbox. Various assistive features are described include automatic summarization and prioritization, placement of key information in the message list view, and personalization to the user. In general, “AI” refers to the use of computing systems to perform intelligent tasks such as language processing, analysis, and problem solving. An example of a model utilizing AI is a Large Language Model (LLM). Although many examples in the present disclosure are illustrated using LLMs, it should be understood that the disclosure can be implemented using other models.

In an embodiment, an event-based assistant (EBA) is triggered in response to the receipt of a message. In an embodiment, the EBA sends the email content to a model such as a Large Language Model (LLM) with a prompt for evaluation. In response to the prompt, the LLM determines each message's relative importance based on one or more criteria. Priorities are assigned to each email and indicated in the message list view. In an embodiment, the user is provided an option to sort the emails in the inbox by priority. In an embodiment, the reading pane includes the reason for the priority assigned to each message. The user is provided an option to provide feedback to improve the email's priority evaluation. More generally, a UI is provided that allows the user to provide inputs that can be used to further guide and improve the prioritization of emails. Examples are provided in the figures which are further described below.

In an embodiment, the EBA personalizes the prioritization of emails by using contextual information for the user. The contextual information can be provided from the address book, including titles and organizational positions of the user, sender, and recipients. In one embodiment, the LLM generates a priority score from 1 to 5. Other priority values and ranges of values can be used in other embodiments, Additionally and optionally, the reasoning behind the score can be provided. Furthermore, a brief headline for the message can be generated, which is displayed in the message list view as a micro summary (e.g., in the subject header). The micro summary is a short headline for what the message thread is about, which can be expanded for a more detailed summary. The summary can be personalized for the user based on the contextual information described above. In some embodiments, it is determined whether the headline is too similar to the subject line. If the headline is too similar to the subject line, then the LLM can be instructed to write a sub headline.

In an embodiment, the user is provided various options for sorting and filtering by priorities and other parameters such as whether the email message is read or unread. For example, the messages can be sorted by priority based on a recent time window. Additionally, user notifications can be adjusted based on priorities, for example by only providing notifications for new high priority messages.

In an embodiment, a UI is provided for the user to provide explicit input to the model for prioritization. The inputs can be facilitated through a combination of menu-driven and text entry fields, for example indicating:
“this message should be marked as high or low priority because . . . ”
“an email is more important if . . . . ”

In an embodiment, the LLM is prompted to determine likely responses that the user can take in response to a message. In response, the LLM generates suggestions for immediate response (e.g., “this is something you should reply to quickly or do you want to schedule a meeting”). The suggestions can be placed on the reading pane for user review/action. Accepting the response causes initiation of the desired action such as launching a reply window with a draft message, or the opening of a document for editing that was discussed in the message—the document can be opened to the section of interest, with proposed edits based on the email context. The highest confidence user actions are rendered on the UI as a set of buttons for user selection. The buttons can be rendered on the message list so that the user need not open the message to initiate the action. Other examples of subject line action buttons include “verify your e-mail address” or “copy verification code.”

### Automatic User View Adjustment

Based on past user preferences, the display view can be re-arranged to provide more detailed views of high priority messages, such as generating a side-by-side view to show message details or to expand the size of high priority messages to reveal relevant portions of a message with respect to the summary or micro summary.

### Subject Line Accuracy

In an embodiment, the LLM is prompted to determine a mismatch between the content of an email or an email conversation, for example if the subject line is not accurate or descriptive of the actual email content. A new subject can be inserted or the preview line in the message view can be rewritten to provide a better summary of the email content.

### Conversation Roll-Up

In an embodiment, email summaries are generated for email conversations which can evolve over multiple email exchanges, referred to as conversation roll up. In some embodiments, the prioritization and micro summary can be generated based on the best message that represents that thread. In one embodiment, the “best” message can be selected based on unread messages in the thread, or the most recent high priority message(s) in the conversation. In one embodiment, the LLM can determine content for each of the messages in the thread and select the most representative message of the current state of the thread. This can be based on one or more criteria or thresholds. In one example, the representative message can be the message that represents a resolution of the topic of the conversation. Conversations that have evolved into multiple topics can be detected, separately summarized, and separately prioritized.

### Enterprise/Personal Contextualization

For emails that are external to the enterprise or organization of the user, the LLM can be prompted to use the user's personal address book for grounding the summaries and priorities. In one example, contacts from the user's personal address book and history of previous communications with these contacts can be used to inform the determination of priorities, summaries, and other features as disclosed herein.

### Generation of LLM Prompt

In an embodiment, the LLM prompt is generated based on user personalization information, user input, and detailed instructions for information for a user. In an example, the instructions can include:
instructions for how to rewrite an email and how to summarize
metadata about the user including enterprise data and user history (e.g., what meetings user has attended, what topics the user has worked on)
specific rules (if—then)
rules repeated in different places which improve LLM accuracy

In one example, the LLM prompt can be based on a collected data set of emails with importance scores X through Z that were assigned by end-users. An LLM is used to describe the properties of the emails with each score. For example, all the emails with scores X, Y, Z can be provided to the LLM and the LLM is prompted to describe their properties. The criteria generated by the LLM can be included in the prompt for prioritizing emails, with additional or modified information as needed or desire, for generating priorities for a future set of emails.

An example LLM prompt is provided below that illustrates how an LLM can be prompted to enable the features discussed herein.
Provide analysis for USER with TITLE by scoring email on priority between x and y where x is low and y is high.

### #Criteria Examples

Email is considered more important based on:
source or recipient(s) of email
role of user in the email content
requests in the email
thread history
   Email is considered less important based on:
size of recipient list
previously responded to
content is generic, promotional, or bulk
email does not require action or comment
email does not relate to USER
   Criteria for the score
“Score_X_Criteria”
“Score_. . _Criteria”
“Score_. . _Criteria”
“Score_. . _Criteria”
“Score_Y_Criteria”
   Rewrite instructions:
preserve main point
qualities of the rewrite
generate executive summary in the first X sentences
requirements for final sentence
tone and focus of the summary
words or content to be excluded
   Examples of emails and their priority

### Reasoning

### Rationale

Final output

### Metadata

### USER

### ORGANIZATIONAL INFORMATION

### Prioritization Rules

important sources
examples of non-important emails
default scores

### Output Rules

Write a paragraph about email's importance.
Revise the score if needed
Compare score with rules and update if needed. For conflicts follow default rule.
Return a priority score on a scale of X through Y
Write a headline with no more than Z words conveying the main point of the email. The headline should not be similar to the email's subject
Write a sub-headline for the email highlighting details not previously captured, with no more than Z words.
If headline and the subject of the email are similar then replace the headline by the sub-headline
Rewrite reasoning and compare the rewritten reasoning against the guidelines.
Concatenate the headline with the rewritten reasoning

Turning now to the figures (which might be referred to herein as a “FIG.” or “FIGS.”), additional details will be provided regarding an improved email interface disclosed herein with reference to the accompanying drawings. The figures show, by way of illustration, specific configurations or examples. Like numerals represent like or similar elements throughout the FIGS. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, AR, VR, and MR devices, video game devices, handheld computers, smartphones, smart televisions, self-driving vehicles, smart watches, e-readers, tablet computing devices, special-purpose hardware devices, network appliances, and the others.

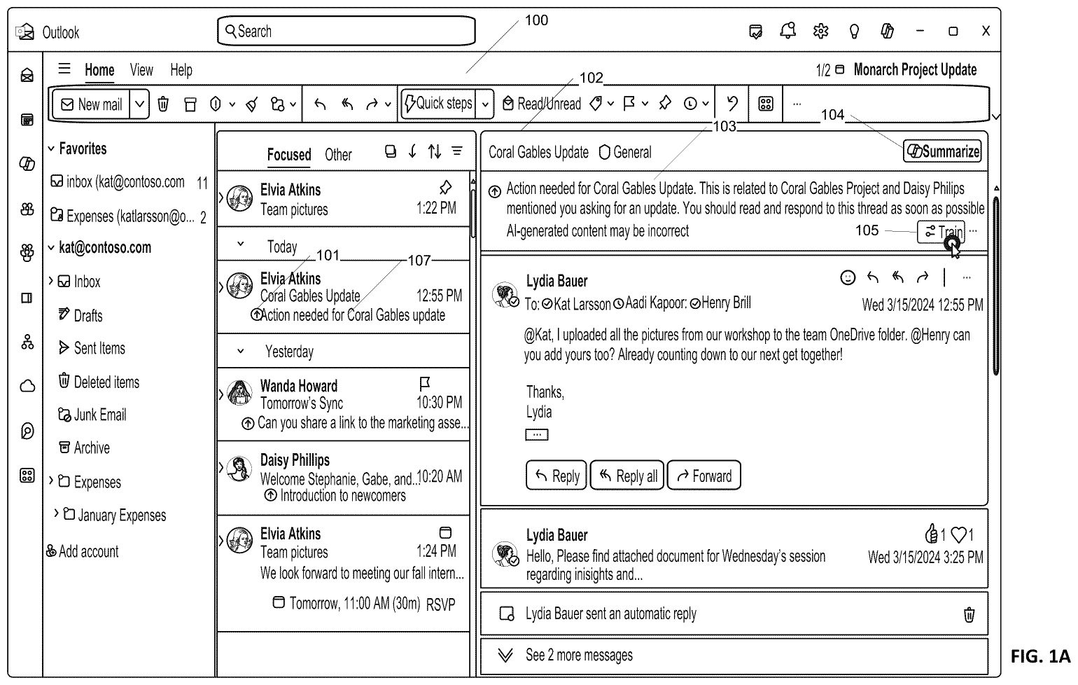

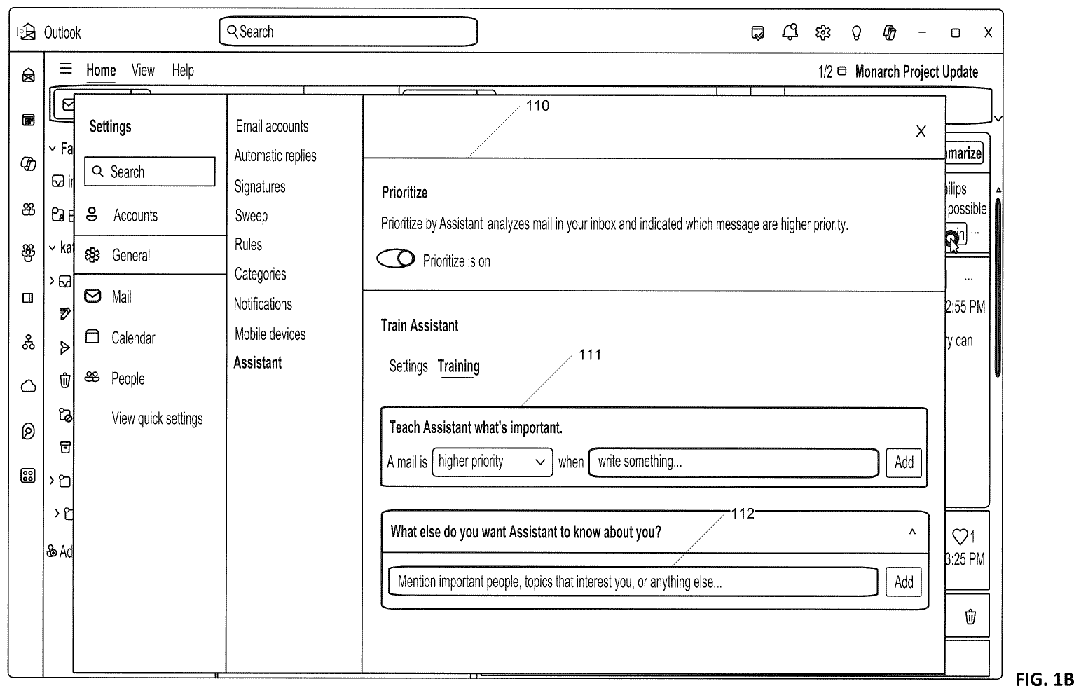

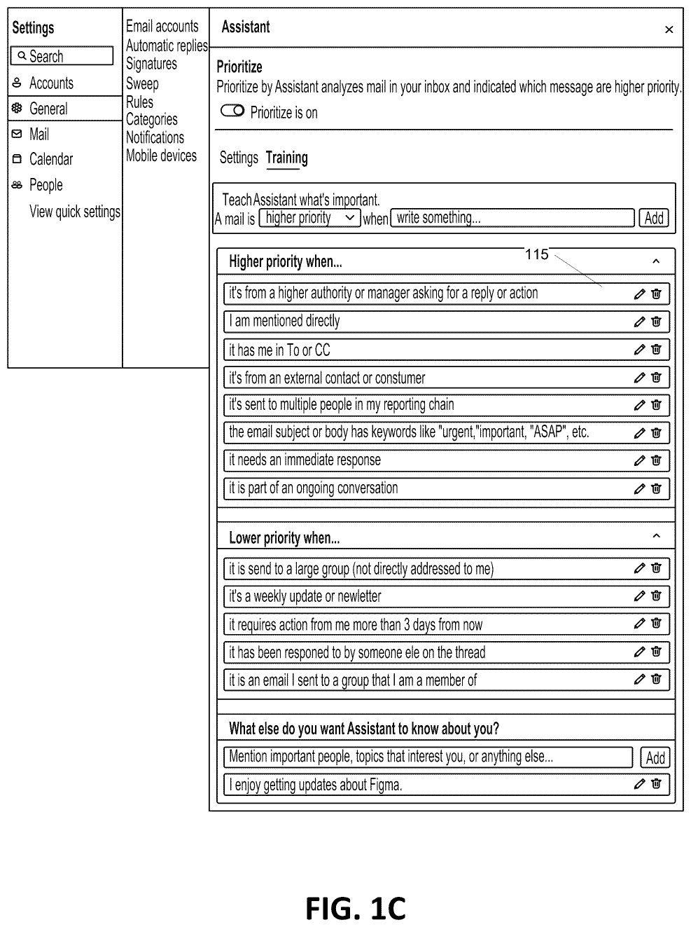

FIG. 1A illustrates an example email UI 100. In an embodiment, one of the messages is associated with an icon 101 indicating a higher priority. In an example, a higher priority is indicated with an up arrow, and a lower priority is indicated with a down arrow. Details for the message are shown in the preview pane 102 which includes a summary 103 that has been generated by an LLM. An option for an additional summary 104 is provided. Additionally, a selectable icon 105 is provided to initiate training input for this message. Further illustrated is an example of a micro-summary 107. In one embodiment, the micro-summary 107 replaces the email preview, which is typically the first few words in the email. In another embodiment, the micro-summary 107 is added as a new line below the email preview.

In one embodiment, FIG. 1B illustrates a training input UI 110 that indicates that the prioritization feature is active. A training input area 111 is rendered that allows the user to indicate that a mail is “higher priority” when a condition is present. Additional input 112 can be provided to further guide the model.

FIG. 1C illustrates an embodiment where conditions 115 are listed for when an email should be prioritized as higher priority. The conditions can be entered manually, or selected from prepopulated templates. The conditions can be edited or deleted.

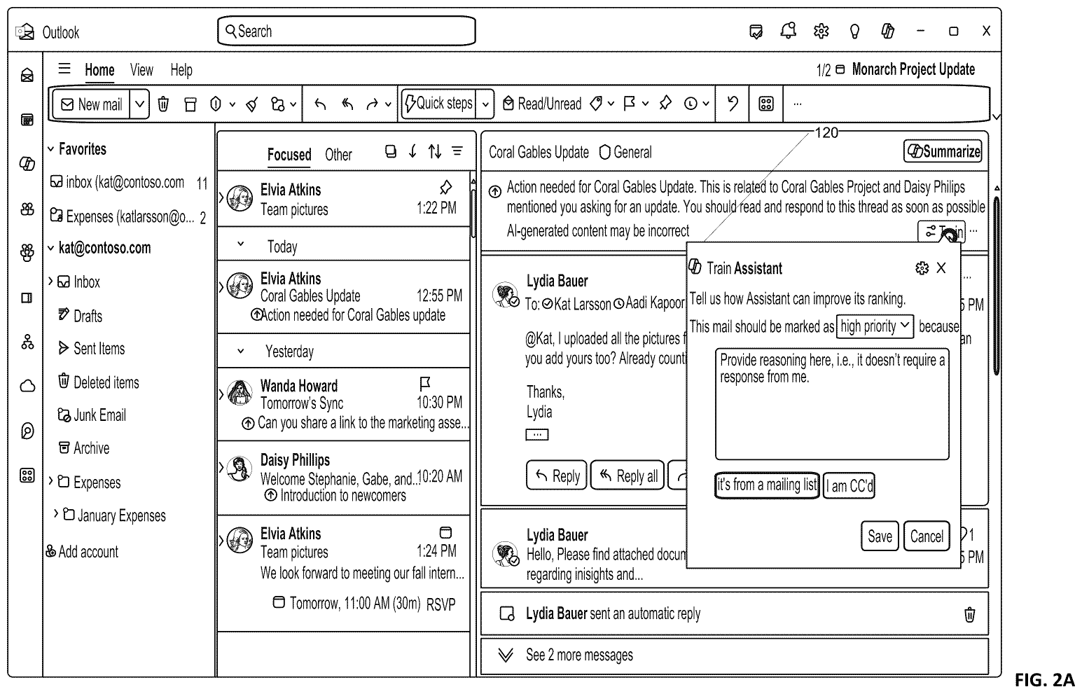

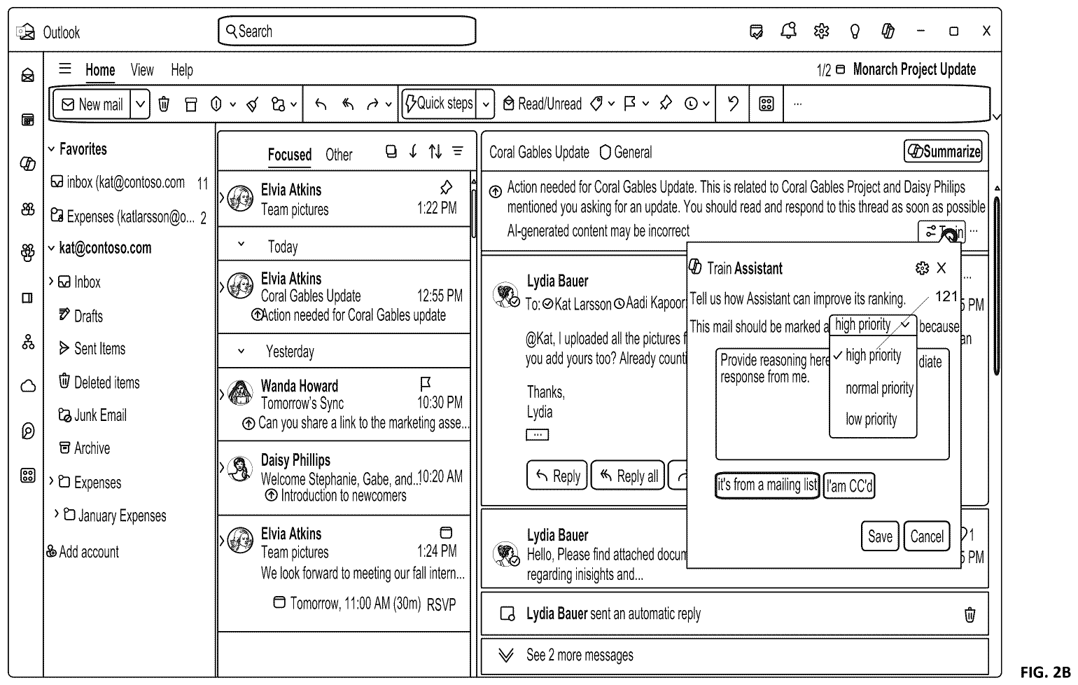

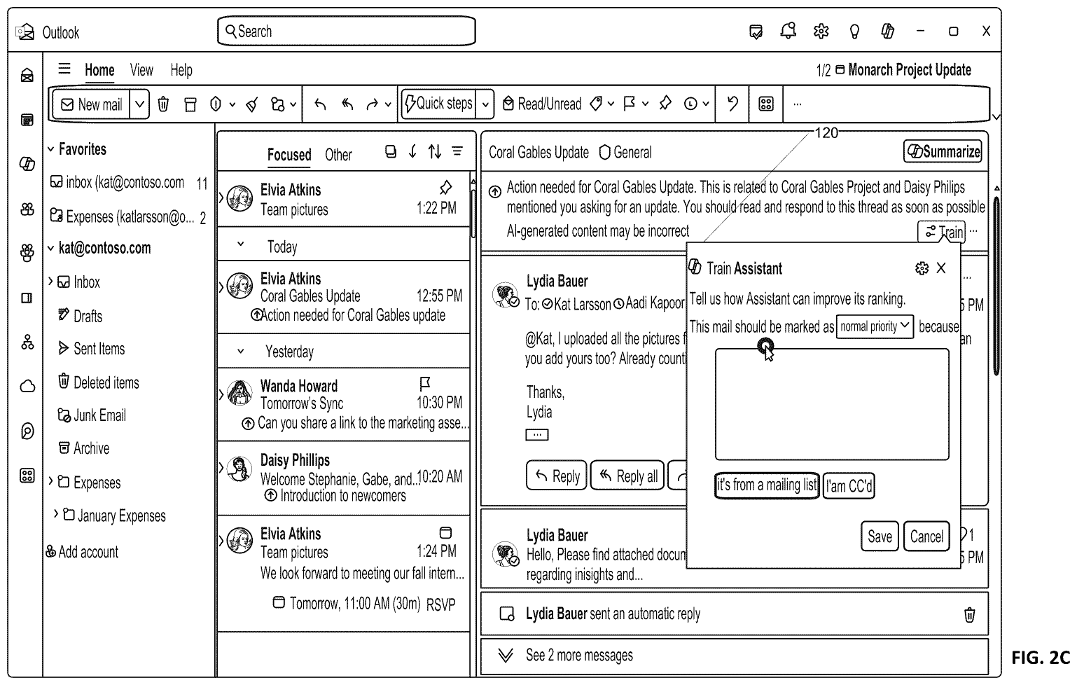

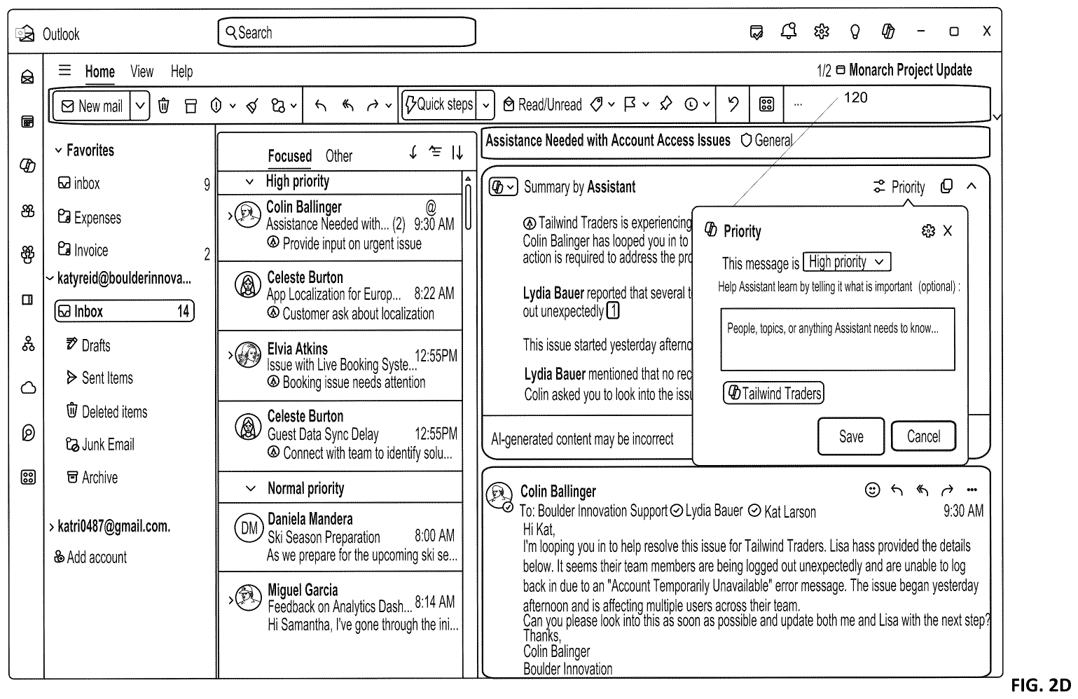

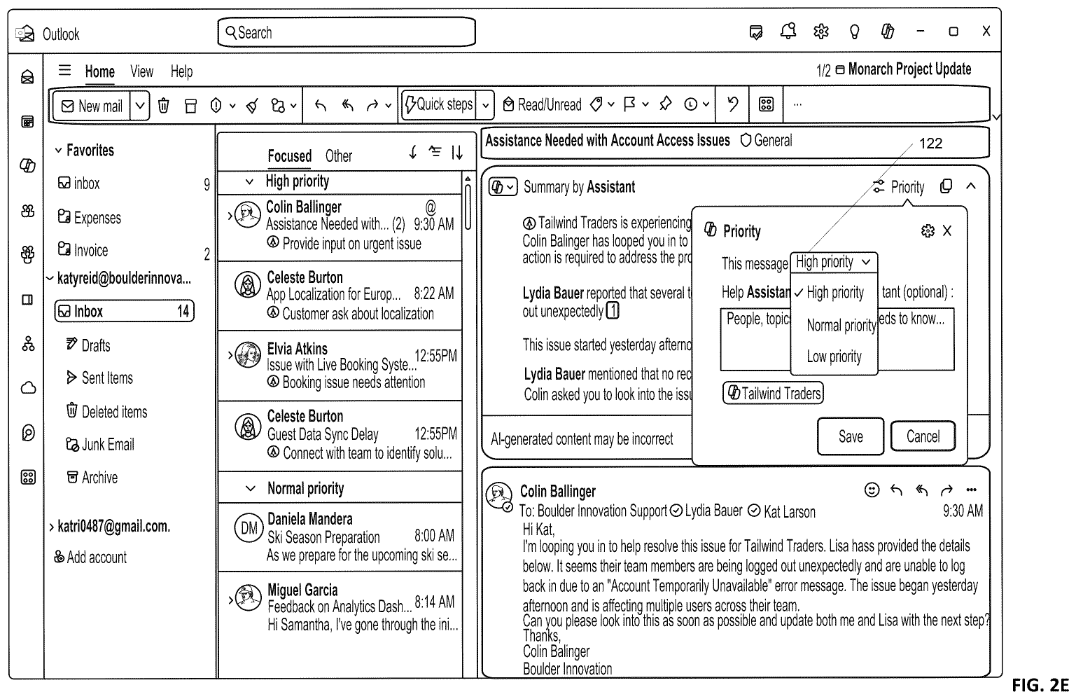

FIG. 2A illustrates an embodiment where an input pane 120 is provided as an overlay. The input pane 120 is provided for a selected email message and allows the user to select or indicate that the email should be a high or other priority, and optionally to provide a reason. In some embodiments, prepopulated reasons can be provided. FIG. 2B shows an example where the priority is selectable in a drop down menu 121, including “high” “normal” and “low” priority. In one embodiment shown in FIG. 2C, an email can be indicated as one of a “high” “normal” and “low” email without explicit rationale. The LLM can use such inputs to further learn example emails for each priority. FIG. 2D illustrates another example where the teaching dialog 120 does not require the user to provide reasoning as to why the email is important or not important. As shown in FIG. 2E, an email can be indicated as one of “high” “normal” and “low” 122 without explicit rationale, in the context of a summary view and a “priority” window. The LLM can use such inputs to further learn example emails for each priority.

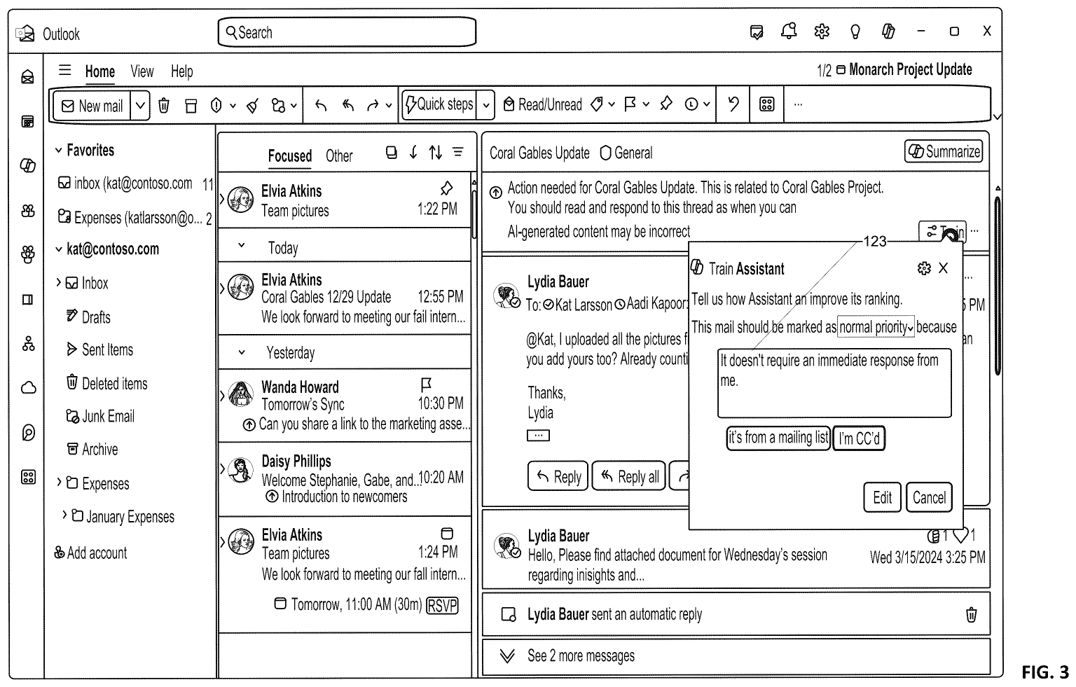

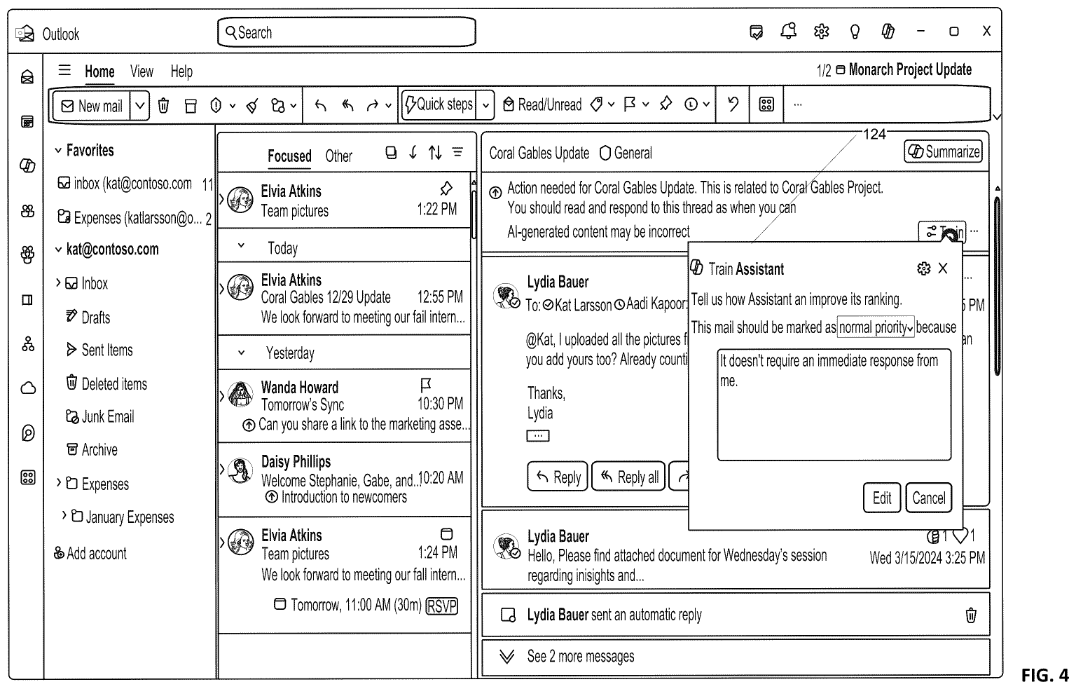

Alternatively, FIG. 3 illustrates that explicit rationale 123 can be entered by the user to further fine tune the prioritization. FIG. 4 illustrates that the training/teaching inputs 124 can be entered and used for processing of emails. In some embodiments, the additional training inputs can be immediately applied to all emails in the user's inbox. In other embodiments, the additional training inputs can be applied to future emails.

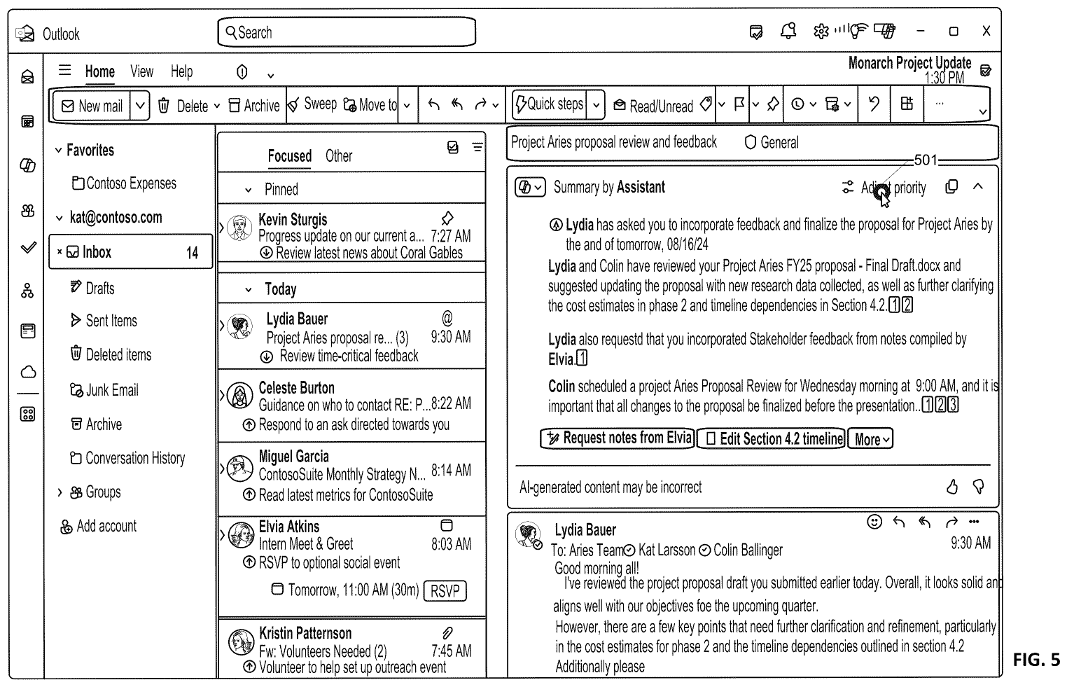

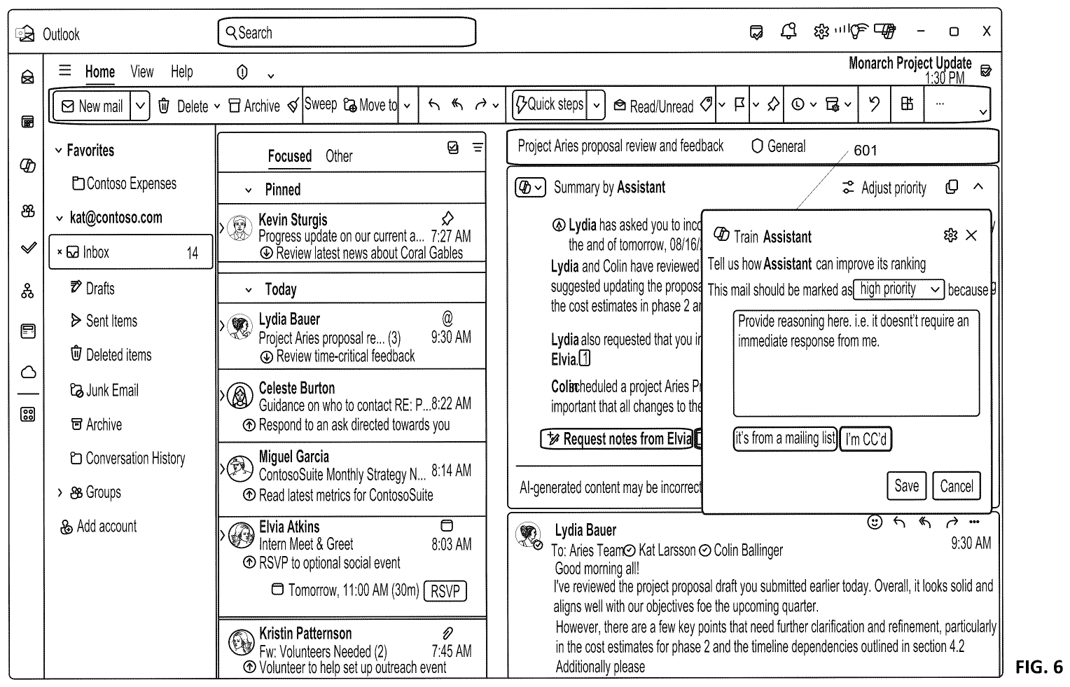

FIG. 5 illustrates additional detail to FIG. 1A, where a user can select an option 501 to adjust priority of an email that has previously been prioritized. FIG. 6 illustrates the rendering of a UI 601 to provide training inputs for what priority should have been assigned to an email.

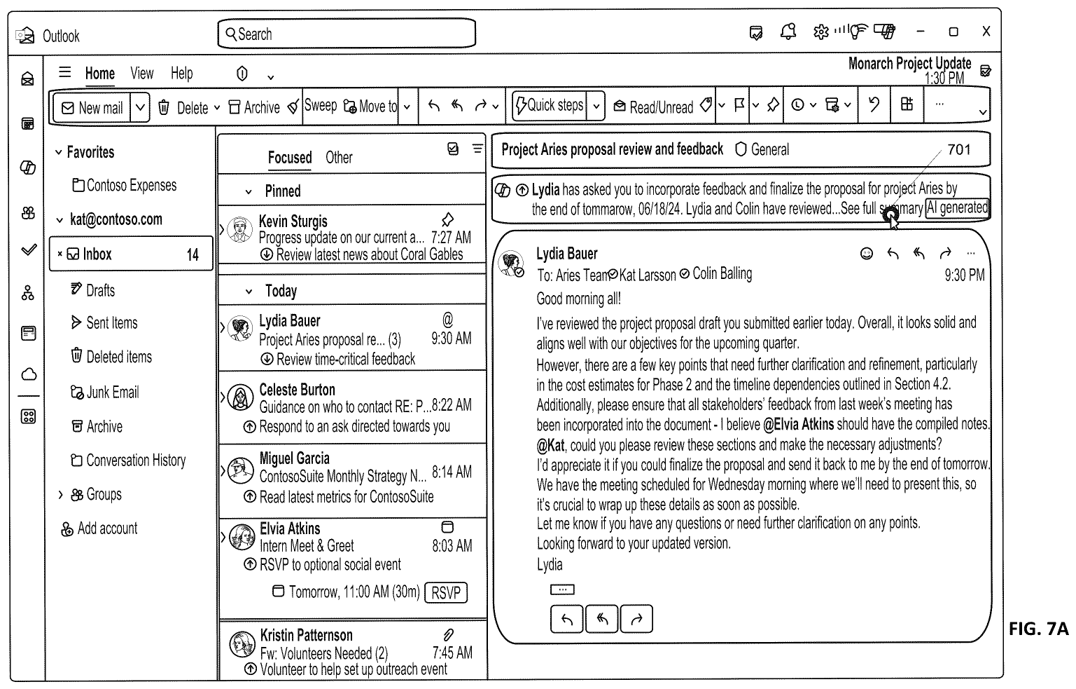

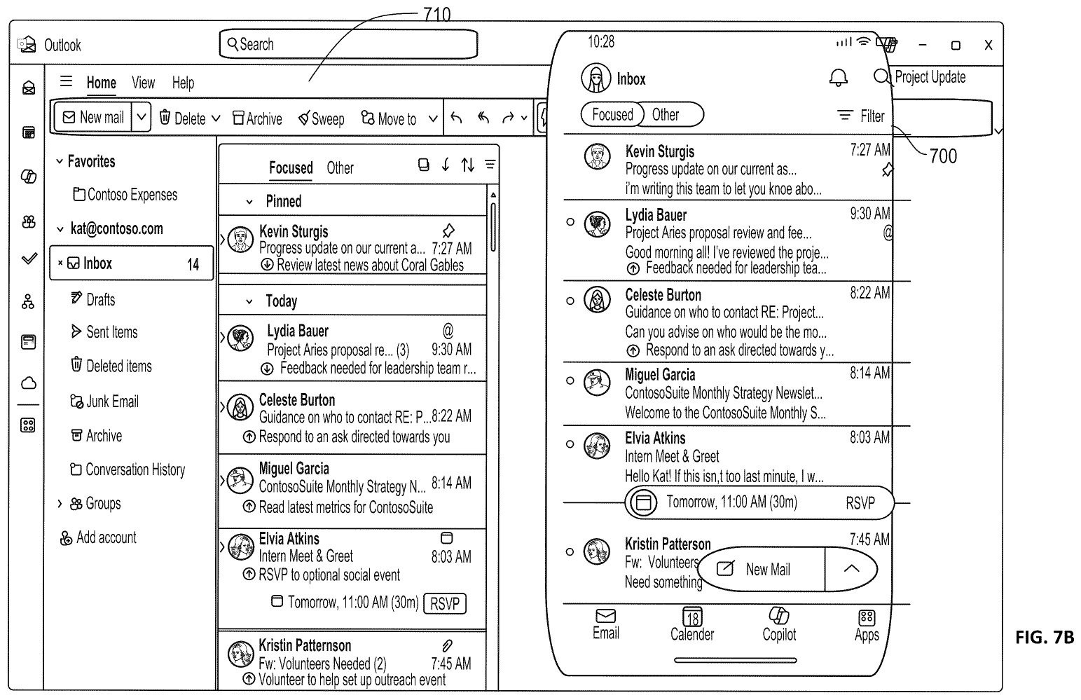

FIG. 7A illustrates additional detail to FIG. 1A, where a user can select an option 701 to view a full summary of an email. FIG. 7B illustrates an example of an implementation on an example mobile device interface which includes a UI 700, shown side by side with a UI 710 rendered on a desktop or similar device.

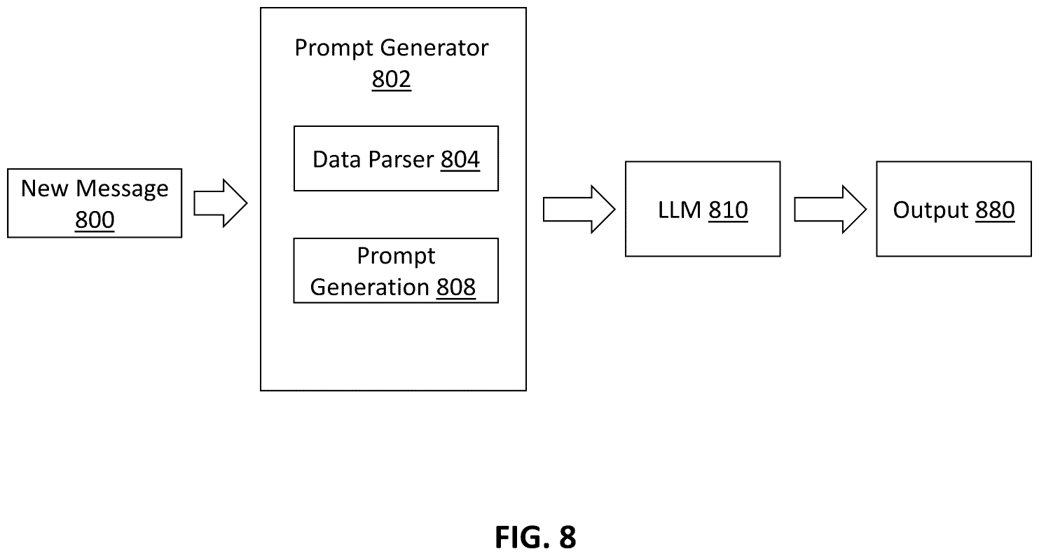

With reference to FIG. 8, illustrated is an example system for using an LLM to analyze emails. A prompt generator 802 receives new message data 800. A data parser 804 takes the input message data to identify content and structure of the input message data 800 and provides the parsed data to a prompt generator 808 which generates a prompt for input to a LLM 810. LLM 810 uses the prompt to generate an output 880.

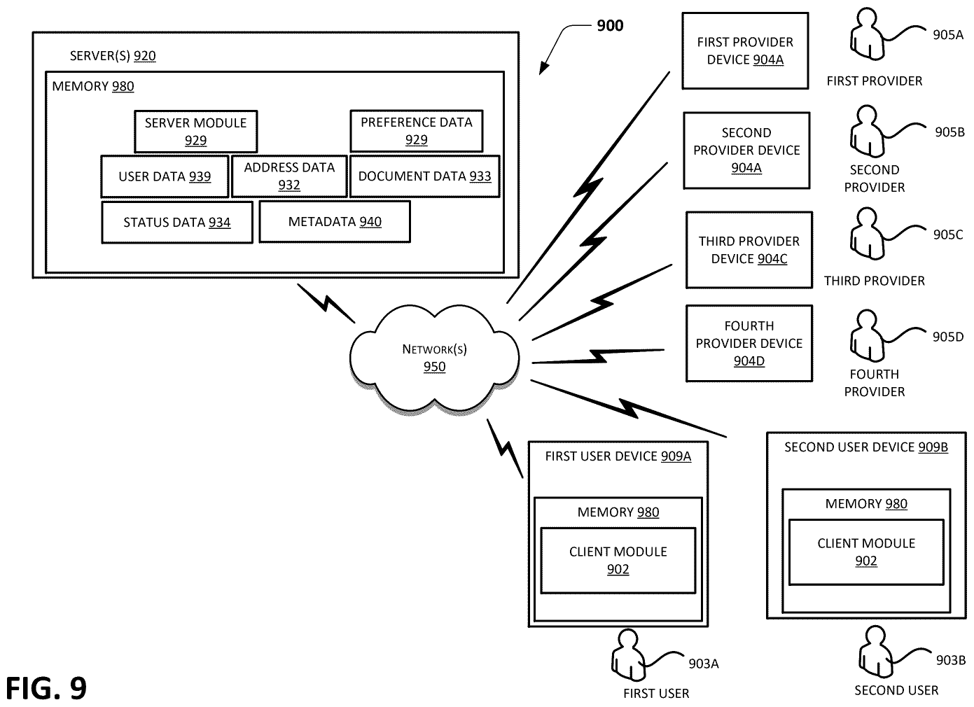

FIG. 9 is a block diagram showing aspects of one example environment 900, also referred to herein as a “system 900,” disclosed herein for providing management of emails. In one illustrative example, the example environment 900 can include one or more servers 920, one or more networks 950, one or more user devices 909A-909B (collectively “user devices 909”), one or more provider devices 904A-904D (collectively “provider devices 904”), and one or more resources 906A-906E (collectively “resources 906”). The user devices 909 can be utilized for interaction with one or more users 903A-903B (collectively “users 903”), and the provider devices 904 can be utilized for interaction with one or more service providers 905A-905D (collectively “service providers 905”). This example is provided for illustrative purposes and is not to be construed as limiting. It can be appreciated that the example environment 900 can include any number of devices, users, providers, and/or any number of servers 920.

For illustrative purposes, the service providers 905 can be a company, person, or any type of entity capable of providing services or products for the users 903, which can also be a company, person or other entity. For illustrative purposes, the service providers 905 and the users 903 can be generically and individually referred to herein as “users.” In some configurations, a data object may include one or more messages. Contextual data can be analyzed to determine one or more messages that can be updated dynamically.

The user devices 909, provider devices 904, servers 920 and/or any other computer configured with the features disclosed herein can be interconnected through one or more local and/or wide area networks, such as the network 950. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A user device 909 or a provider device 904 (collectively “computing devices”) can operate as a stand-alone device, or such devices can operate in conjunction with other computers, such as the one or more servers 920. Individual computing devices can be in the form of a personal computer, mobile phone, tablet, wearable computer, including a head-mounted display (HMD) or watch, or any other computing device having components for interacting with one or more users and/or remote computers. In one illustrative example, the user device 909 and the provider device 904 can include a local memory 980, also referred to herein as a “computer-readable storage medium” or “non-transitory computer-readable storage medium” configured to store data, such as a client module 902 and other contextual data described herein.

The servers 920 may be in the form of a personal computer, server farm, large-scale system or any other computing system having components for processing, coordinating, collecting, storing, and/or communicating data between one or more computing device. In one illustrative example, the servers 920 can include a local memory 980, also referred to herein as a “computer-readable storage medium,” configured to store data, such as a server module 920 and other data described herein. The servers 920 can also include components and services, such as the application services and shown in FIG. 9, for providing, receiving, and processing email data and executing one or more aspects of the techniques described herein. As will be described in more detail herein, any suitable module may operate in conjunction with other modules or devices to implement aspects of the techniques disclosed herein.

In some configurations, an application programming interface (API) exposes an interface through which an operating system and application programs executing on the computing device can enable the functionality disclosed herein. Through the use of this data interface and other interfaces, the operating system and application programs can communicate and process contextual data and modify scheduling data as described herein.

The user data 939 can include various data for the users 903 and the providers 905. The user data 939 can include communication information such as a email address, job title, or other information. The user data 939 can be stored on the server 920, user device 909, provider device 904, or any suitable computing device, which may include a Web-based service.

The address data 932 may include address information for the user's contacts. The address data 932 can also be based on user data 939. These examples are provided for illustrative purposes and are not to be construed as limiting. The preference data 929 can include user-defined preferences or provider-defined preferences.

To enable aspects of the techniques disclosed herein, one or more computing devices of FIG. 9 can be configured to generate data defining one or more live updates in response to detecting the presence of a condition. The implementations can include obtaining contextual data from a plurality of resources.

One or more computing devices can be configured to identify a pattern of the contextual data indicating a presence of a condition that affects one or more aspects of an email.

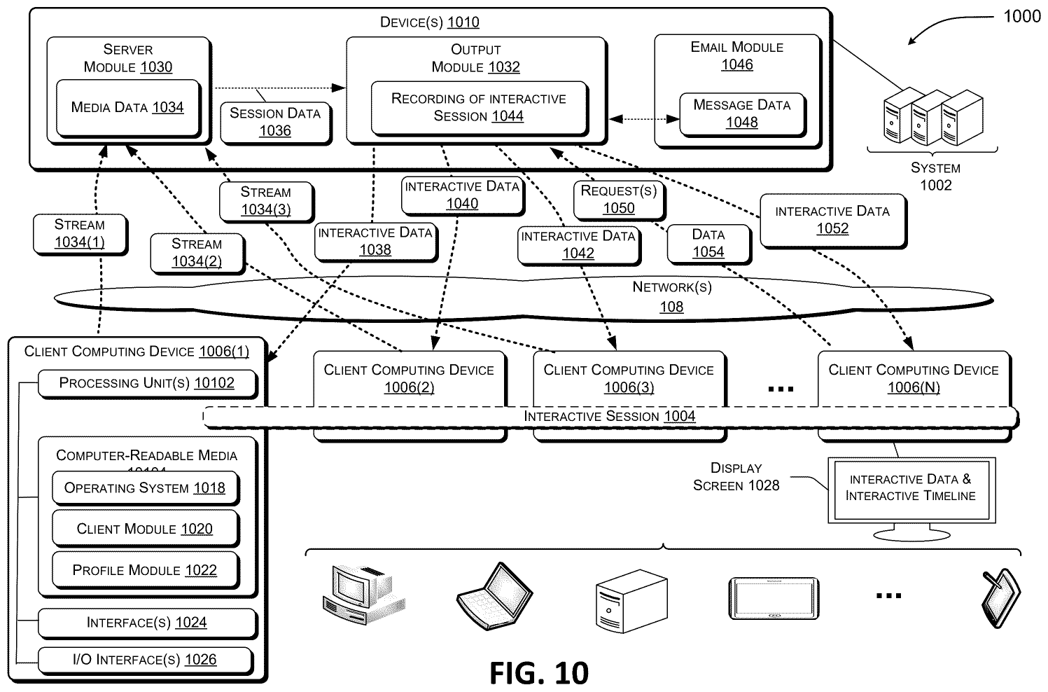

FIG. 10 is a diagram illustrating an example environment 1000 in which a system 1002 can operate to generate email information for an interactive session 1004 and to save and edit content. In this example, an interactive session 1004 is implemented between a number of client computing devices 1006(1) through 1006(N) (where N is a positive integer number having a value of two or greater). The client computing devices 1006(1) through 1006(N) enable users to participate in the interactive session 1004. In this example, the interactive session 1004 is hosted, over one or more network(s) 1008, by the system 1002. That is, the system 1002 can provide a service that enables users of the client computing devices 1006(1) through 1006(N) to participate in the interactive session 1004 (e.g., via a live viewing and/or a recorded viewing). Consequently, a “participant” to the interactive session 1004 can comprise a user and/or a client computing device (e.g., multiple users may be in a conference room participating in a interactive session via the use of a single client computing device), each of which can communicate with other participants. As an alternative, the interactive session 1004 can be hosted by one of the client computing devices 1006(1) through 1006(N) utilizing peer-to-peer technologies.

In examples described herein, client computing devices 1006(1) through 1006(N) participating in an interactive session 1004 are configured to receive and render for display, on a user interface of a display screen, interactive data. The interactive data can comprise a collection of various instances, or streams, of content. For example, an individual stream of content can comprise media data associated with a video feed (e.g., audio and visual data that capture the appearance and speech of a user participating in the interactive session). Another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 1002 includes device(s) 10100. The device(s) 10100 and/or other components of the system 1002 can include distributed computing resources that communicate with one another and/or with the client computing devices 1006(1) through 1006(N) via the one or more network(s) 1008. In some examples, the system 1002 may be an independent system that is tasked with managing aspects of one or more interactive sessions such as interactive session 1004. As an example, the system 1002 may be managed by entities such as SLACK, WEBEX, GOTOMEETING, GOOGLE HANGOUTS, etc.

Network(s) 1008 may include, for example, public networks such as the Internet, private networks such as an institutional and/or personal intranet, or some combination of private and public networks. Network(s) 1008 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 1008 may utilize communications protocols, including packet-based and/or datagram-based protocols such as Internet protocol (“IP”), transmission control protocol (“TCP”), user datagram protocol (“UDP”), or other types of protocols. Moreover, network(s) 1008 may also include a number of devices that facilitate network communications and/or form a hardware basis for the networks, such as switches, routers, gateways, access points, firewalls, base stations, repeaters, backbone devices, and the like.

In some examples, network(s) 1008 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.101 standards (e.g., 802.101g, 802.101n, and so forth), and other standards.

In various examples, device(s) 10100 may include one or more computing devices that operate in a cluster or other grouped configuration to share resources, balance load, increase performance, provide fail-over support or redundancy, or for other purposes. For instance, device(s) 10100 may belong to a variety of classes of devices such as traditional server-type devices, desktop computer-type devices, and/or mobile-type devices. Thus, although illustrated as a single type of device—a server-type device—device(s) 10100 may include a diverse variety of device types and are not limited to a particular type of device. Device(s) 10100 may represent, but are not limited to, server computers, desktop computers, web-server computers, personal computers, mobile computers, laptop computers, tablet computers, or any other sort of computing device.

A client computing device (e.g., one of client computing device(s) 1006(1) through 1006(N)) (each of which are also referred to herein as a “data processing system”) may belong to a variety of classes of devices, which may be the same as, or different from, device(s) 10100, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1006(1) through 1006(N) of the various classes and device types can represent any type of computing device having one or more processing unit(s) 10102 operably connected to computer-readable media 10104 such as via a bus 1016, which in some instances can include one or more of a system bus, a data bus, an address bus, a PCI bus, a Mini-PCI bus, and any variety of local, peripheral, and/or independent buses.

Executable instructions stored on computer-readable media 10104 may include, for example, an operating system 1018, a client module 1020, a profile module 1022, and other modules, programs, or applications that are loadable and executable by processing units(s) 10102.

Client computing device(s) 1006(1) through 1006(N) may also include one or more interface(s) 1024 to enable communications between client computing device(s) 1006(1) through 1006(N) and other networked devices, such as device(s) 10100, over network(s) 1008. Such network interface(s) 1024 may include one or more network interface controllers (NICs) or other types of transceiver devices to send and receive communications and/or data over a network. Moreover, a client computing device 1006(1) can include input/output (“I/O”) interfaces 1026 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 100 illustrates that client computing device 1006(N) is in some way connected to a display device (e.g., a display screen 1028), which can display the interactive timeline for the interactive session 1004, as shown.

In the example environment 10000 of FIG. 100, client computing devices 1006(1) through 1006(N) may use their respective client modules 1020 to connect with one another and/or other external device(s) in order to participate in the interactive session 1004. For instance, a first user may utilize a client computing device 1006(1) to communicate with a second user of another client computing device 1006(2). When executing client modules 1020, the users may share data, which may cause the client computing device 1006(1) to connect to the system 1002 and/or the other client computing devices 1006(2) through 1006(N) over the network(s) 1008.

The client computing device(s) 1006(1) through 1006(N) may use their respective profile module 1022 to generate participant profiles and provide the participant profiles to other client computing devices and/or to the device(s) 10100 of the system 1002. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for interactive sessions.

As shown in FIG. 10, the device(s) 1010 of the system 1002 includes a server module 1030 and an output module 1032. The server module 1030 is configured to receive, from individual client computing devices such as client computing devices 1006(1) through 1006(3), media streams 1034(1) through 1034(3). As described above, media streams can comprise a video feed (e.g., audio and visual data associated with a user), audio data which is to be output (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1030 is configured to receive a collection of various media streams 1034(1) through 1034(3) (the collection being referred to herein as media data 1034). In some scenarios, not all the client computing devices that participate in the interactive session 1004 provide a media stream. For example, a client computing device may only be a consuming, or a “listening”, device such that it only receives content associated with the interactive session 1004 but does not provide any content to the interactive session 1004.

The server module 1030 is configured to generate session data 1036 based on the media data 1034. In various examples, the server module 1030 can select aspects of the media data 1034 that are to be shared with the participating client computing devices 1006(1) through 1006(N). Consequently, the server module 1030 is configured to pass the session data 1036 to the output module 1032 and the output module 1032 may communicate teleconference data to the client computing devices 1006(1) through 1006(3). As shown, the output module 1032 transmits teleconference data 1038 to client computing device 1006(1), transmits teleconference data 1040 to client computing device 1006(2), and transmits interactive data 1042 to client computing device 1006(3). The interactive data transmitted to the client computing devices can be the same or can be different (e.g., positioning of streams of content within a user interface may vary from one device to the next). The output module 1032 is also configured to record the interactive session (e.g., a version of the interactive data) and to maintain a recording of the interactive session 1044.

The device(s) 1010 can also include a email module 1046, and in various examples, the email module 1046 is configured to manage message data 1048 in the session data 1036 and/or events relevant to interactive session 1044.

A client computing device such as client computing device 1006(N) can provide a request 150 to view a recording of the interactive session 1004. In response, the output module 1032 can provide interactive data and interactive data 152 to be displayed on a display screen 1028 associated with the client computing device 1006(N). The teleconference data transmitted to client computing device 1006(N) comprises previously recorded content of the interactive session 1004. As further described herein, a user of client computing device 1006(N) can provide input(s) to add supplemental recorded content to the interactive session 1004 and/or to the interactive timeline, and data 154 associated with the supplemental recorded content can be transmitted from client computing device 1006(N) to the system 1002 so that the recording of the interactive session 1044 and the interactive timeline can be updated with the supplemental recorded content. This enables other participants (e.g., users of client computing devices 1006(1) through 1006(3)) to consume or view the supplemental recorded content after the live viewing of the interactive session has already ended. An improved human-computer interface (“HCI”) is disclosed herein for interacting with representations of emails and email content. In some embodiments, the email information may be presented in conjunction with a communications platform such as a videoconferencing platform. Such a system may be referred to as an interactive email system.

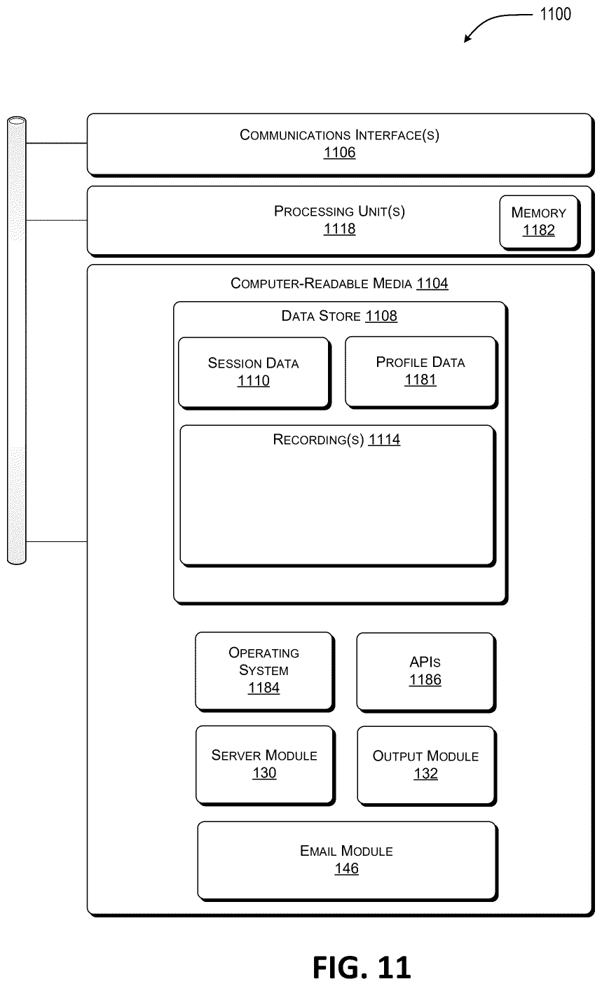

FIG. 11 illustrates a diagram that shows example components of an example device 1100 configured to render and update email data. The device 1100 may represent one of device(s) 106, or in other examples a client computing device (e.g., client computing device 106(1)), where the device 1100 includes one or more processing unit(s) 1118, computer-readable media 1104, and communication interface(s) 1106. The components of the device 1100 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 1118 and/or processing unit(s) 1111, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 1104, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 1106 may represent, for example, network interface controllers (“NICs”) or other types of transceiver devices to send and receive communications over a network.

In the illustrated example, computer-readable media 1104 includes a data store 1108. In some examples, data store 1108 includes data storage such as a database, data warehouse, or other type of structured or unstructured data storage. In some examples, data store 1108 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 1108 may store data for the operations of processes, applications, components, and/or modules stored in computer-readable media 1104 and/or executed by processing unit(s) 1118 and/or accelerator(s). For instance, in some examples, data store 1108 may store session data 1110 (e.g., session data 136), profile data 1181 (e.g., associated with a participant profile), and/or other data. The session data 1110 can include a total number of participants (e.g., users and/or client computing devices) in the interactive session 1004, and activity that occurs in the interactive session 1004, and/or other data related to when and how the interactive session 1004 is conducted or hosted. The data store 1108 can also include recording(s) 1114 of interactive session(s).

Alternately, some or all of the above-referenced data can be stored on separate memories 1182 on board one or more processing unit(s) 1118 such as a memory on board a CPU-type processor, a GPU-type processor, an FPGA-type accelerator, a DSP-type accelerator, and/or another accelerator. In this example, the computer-readable media 1104 also includes operating system 1184 and application programming interface(s) 1186 configured to expose the functionality and the data of the device 1100 to other devices. Additionally, the computer-readable media 1104 includes one or more modules such as the server module 130, the output module 132, and the email module 146, although the number of illustrated modules is just an example, and the number may vary higher or lower. That is, functionality described herein in association with the illustrated modules may be performed by a fewer number of modules or a larger number of modules on one device or spread across multiple devices.

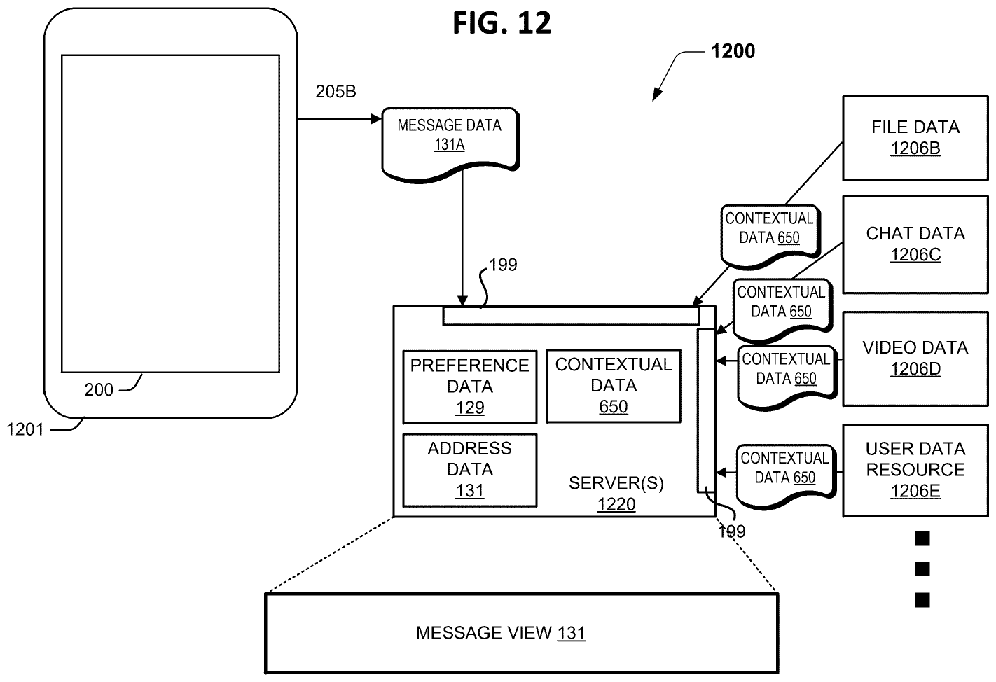

FIG. 12 illustrates aspects of the system 1200 that provide a framework for several example scenarios utilizing the techniques disclosed herein. More specifically, this block diagram of the system 1200 shows an illustrative example of the server 1220 receiving message data 131 defining a scheduled meeting. The server 1220 is also storing message data 131 defining a number of messages for a user and preference data 129. The server 1220 also receives contextual data 650 from a number of resources 1206A-1206E, as well as other resources described herein. To illustrate aspects of the examples described below, the user device 1201 is displaying a user interface (UI) 200 showing a message view.

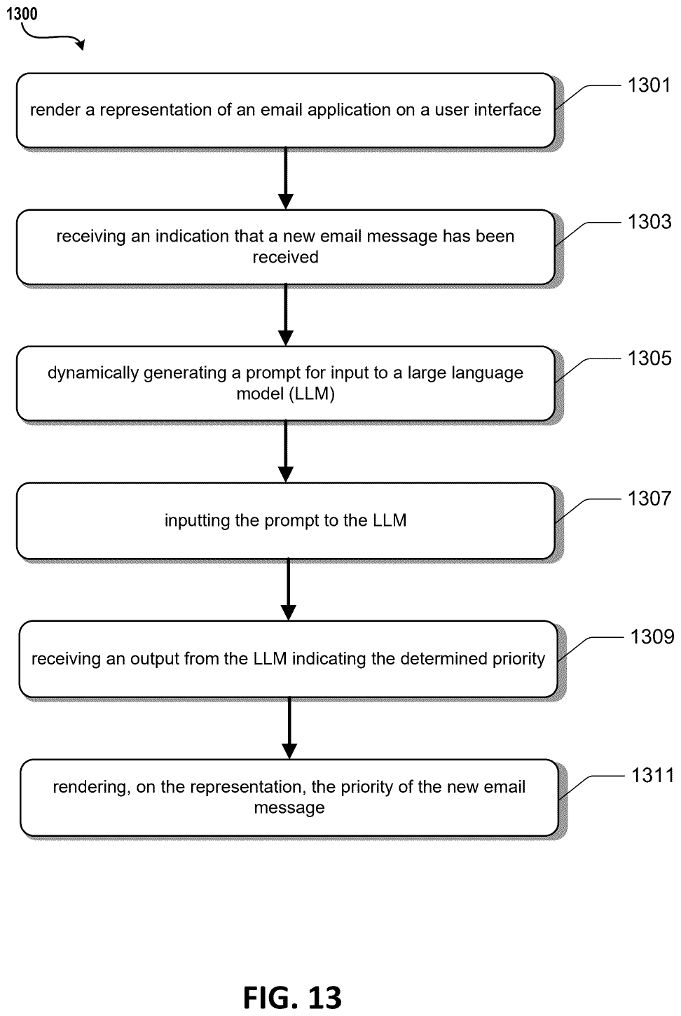

FIG. 13 is a diagram illustrating aspects of a routine 1300 according to one embodiment disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 13 and the other FIGS. can be implemented in association with the example presentation GUIs described above with respect to FIGS. 1 through 12.

Referring to FIG. 13, operation 1301 illustrates rendering a representation of an email application on a user interface (UI). In an embodiment, the representation includes at least one email message or a message view comprising a plurality of email messages.

Operation 1303 illustrates receiving an indication that a new email message has been received.

Operation 1305 illustrates in response to receiving the indication, dynamically generating a prompt for input to a large language model (LLM). In an embodiment, the prompt is usable to cause the LLM to analyze content of the new email message and determine a priority of the new email message. In an embodiment, the priority is localized to a context based at least in part by a recipient and sender of the new email message.

Operation 1307 illustrates inputting the prompt to the LLM.

Operation 1309 illustrates receiving an output from the LLM indicating the determined priority.

Operation 1311 illustrates rendering, on the representation, the determined priority of the new email message.

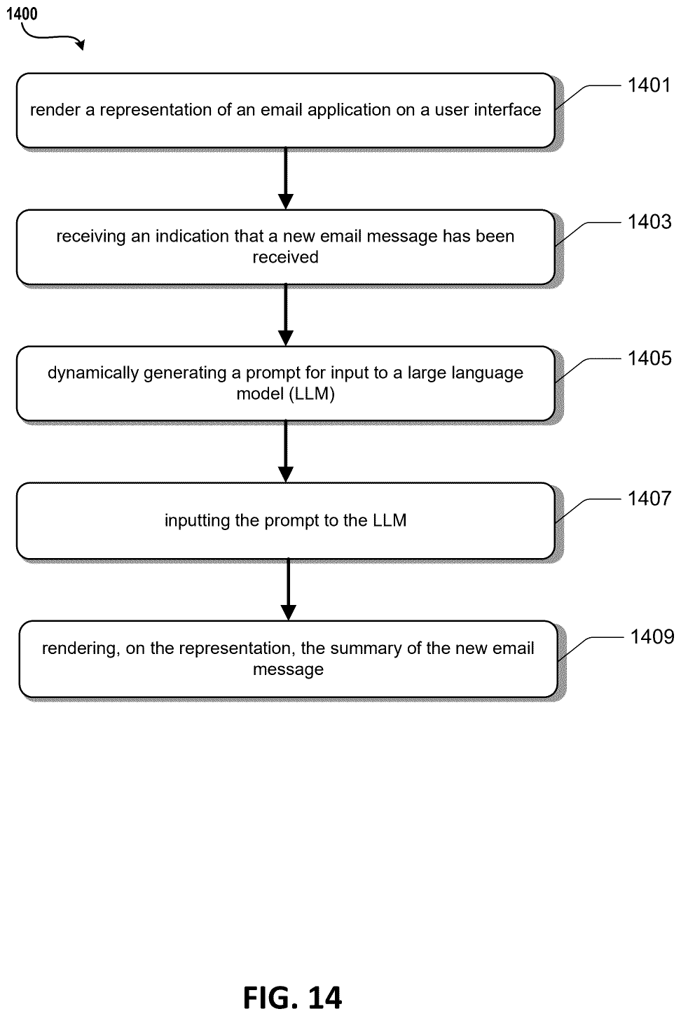

FIG. 14 is a diagram illustrating aspects of a routine 1400 according to one embodiment disclosed herein.

Referring to FIG. 14, operation 1401 illustrates rendering a representation of an email application on a user interface (UI), the representation including at least one email message or a message view comprising a plurality of email messages.

Operation 1403 illustrates receiving an indication that a new email message has been received.

Operation 1405 illustrates in response to receiving the indication, dynamically generating a prompt for input to a large language model (LLM). In an embodiment, the prompt is usable to cause the LLM to analyze content of the new email message and determine a summary of the new email message. In an embodiment, the summary is determined at least in part by a context of the new email message.

Operation 1407 illustrates inputting the prompt to the LLM.

Operation 1409 illustrates rendering, on the representation, the summary of the new email message.

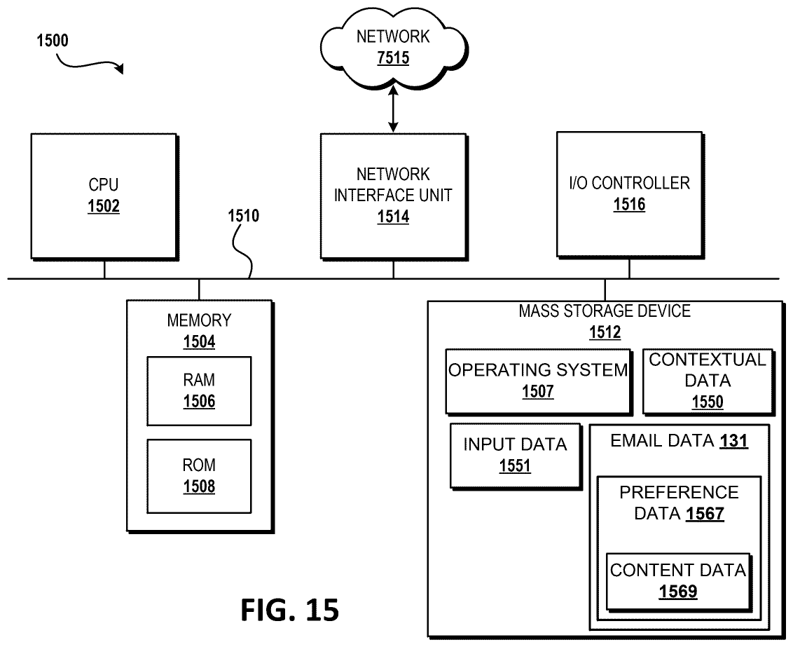

FIG. 15 shows additional details of an example computer architecture 1500 for a computer, such as any of the computing devices depicted in FIGS. 1-14, capable of executing the program components described herein. Thus, the computer architecture 1500 illustrated in FIG. 15 illustrates an architecture for a server computer, mobile phone, a PDA, a smart phone, a desktop computer, a netbook computer, a tablet computer, and/or a laptop computer. The computer architecture 1500 may be utilized to execute any aspects of the software components presented herein.

The computer architecture 1500 illustrated in FIG. 15 includes a central processing unit 1502 (“CPU”), a system memory 1504, including a random access memory 15015 (“RAM”) and a read-only memory (“ROM”) 1508, and a system bus 1510 that couples the memory 1504 to the CPU 1502. A basic input/output system containing the basic routines that help to transfer information between elements within the computer architecture 1500, such as during startup, is stored in the ROM 1508. The computer architecture 1500 further includes a mass storage device 1512 for storing an operating system 1507, data, such as the contextual data 1550, input data 1551, message data 131, preference data 1567, content data 1569, and one or more application programs (not depicted in FIG. 15).

The mass storage device 1512 is connected to the CPU 1502 through a mass storage controller (not shown) connected to the bus 1510. The mass storage device 1512 and its associated computer-readable media provide non-volatile storage for the computer architecture 1500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1500. For purposes the claims, the phrase “computer storage medium,” “computer-readable storage medium” and variations thereof, does not include waves, signals, and/or other transitory and/or intangible communication media, per se.

According to various configurations, the computer architecture 1500 may operate in a networked environment using logical connections to remote computers through the network 7515 and/or another network (not shown). The computer architecture 1500 may connect to the network 7515 through a network interface unit 1514 connected to the bus 1510. It should be appreciated that the network interface unit 1514 also may be utilized to connect to other types of networks and remote computer systems. The computer architecture 1500 also may include an input/output controller 1516 for receiving and processing input from a number of other devices, including a keyboard, mouse, or electronic stylus (not shown in FIG. 15). Similarly, the input/output controller 1516 may provide output to a display screen, a printer, or other type of output device (also not shown in FIG. 15).

It should be appreciated that the software components described herein may, when loaded into the CPU 1502 and executed, transform the CPU 1502 and the overall computer architecture 1500 from a general-purpose computing system into a special-purpose computing system customized to facilitate the functionality presented herein. The CPU 1502 may be constructed from any number of transistors or other discrete circuit elements, which may individually or collectively assume any number of states. More specifically, the CPU 1502 may operate as a finite-state machine, in response to executable instructions contained within the software modules disclosed herein. These computer-executable instructions may transform the CPU 1502 by specifying how the CPU 1502 transitions between states, thereby transforming the transistors or other discrete hardware elements constituting the CPU 1502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1500 in order to store and execute the software components presented herein. It also should be appreciated that the computer architecture 1500 may include other types of computing devices, including hand-held computers, embedded computer systems, personal digital assistants, and other types of computing devices known to those skilled in the art. It is also contemplated that the computer architecture 1500 may not include all of the components shown in FIG. 15, may include other components that are not explicitly shown in FIG. 15, or may utilize an architecture completely different than that shown in FIG. 15.

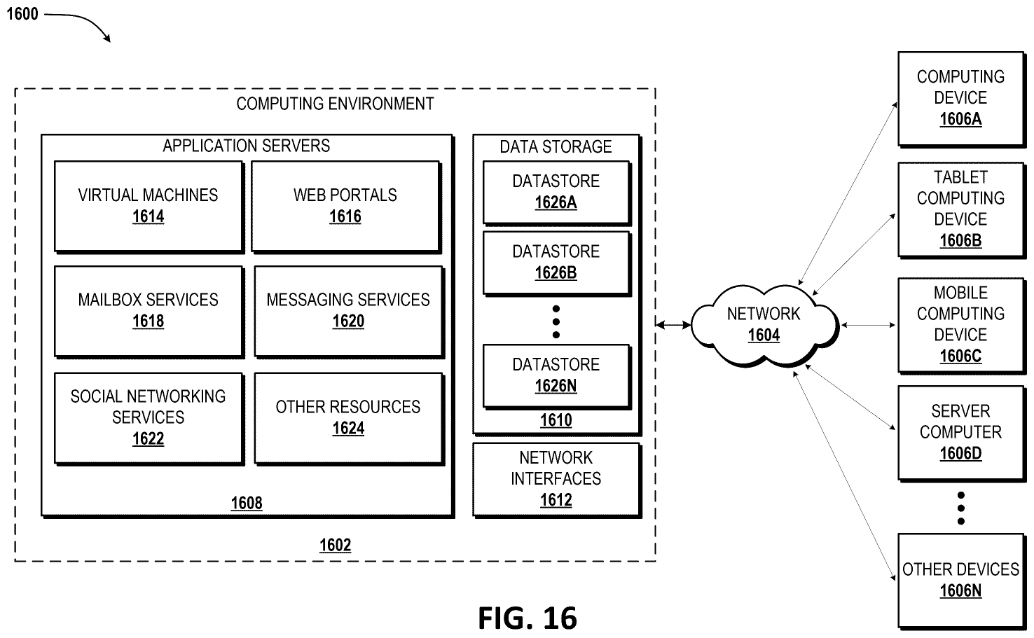

FIG. 16 depicts an illustrative distributed computing environment 1600 capable of executing the software components described herein for providing contextually-aware insights into email messages. Thus, the distributed computing environment 1600 illustrated in FIG. 16 can be utilized to execute any aspects of the software components presented herein. For example, the distributed computing environment 1600 can be utilized to execute aspects of the software components described herein.

According to various implementations, the distributed computing environment 1600 includes a computing environment 1602 operating on, in communication with, or as part of the network 1604. The network 1604 may be or may include the network 1656, described above. The network 1604 also can include various access networks. One or more client devices 1606A-1606N (hereinafter referred to collectively and/or generically as “clients 1606”) can communicate with the computing environment 1602 via the network 1604 and/or other connections (not illustrated in FIG. 16). In one illustrated configuration, the clients 1606 include a computing device 1606A such as a laptop computer, a desktop computer, or other computing device; a slate or tablet computing device (“tablet computing device”) 1606B; a mobile computing device 1606C such as a mobile telephone, a smart phone, or other mobile computing device; a server computer 1606D; and/or other devices 1606N. It should be understood that any number of clients 1606 can communicate with the computing environment 1602. Two example computing architectures for the clients 1606 are illustrated and described herein with reference to FIGS. 1-15. It should be understood that the illustrated clients 1606 and computing architectures illustrated and described herein are illustrative, and should not be construed as being limited in any way.

In the illustrated configuration, the computing environment 1602 includes application servers 1608, data storage 1610, and one or more network interfaces 1612. According to various implementations, the functionality of the application servers 1608 can be provided by one or more server computers that are executing as part of, or in communication with, the network 1604. The application servers 1608 can host various services, virtual machines, portals, and/or other resources. In the illustrated configuration, the application servers 1608 host one or more virtual machines 1614 for hosting applications or other functionality. According to various implementations, the virtual machines 1614 host one or more applications and/or software modules for providing contextually-aware insights into email messages. It should be understood that this configuration is illustrative, and should not be construed as being limiting in any way. The application servers 1608 also host or provide access to one or more portals, link pages, Web sites, and/or other information (“Web portals”) 1616.

According to various implementations, the application servers 1608 also include one or more mailbox services 1618 and one or more messaging services 1620. The mailbox services 1618 can include electronic mail (“email”) services. The mailbox services 1618 also can include various personal information management (“PIM”) services including, but not limited to, calendar services, contact management services, collaboration services, and/or other services. The messaging services 1620 can include, but are not limited to, instant messaging services, chat services, forum services, and/or other communication services.

The application servers 1608 also may include one or more social networking services 1622. The social networking services 1622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 1622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 1622 are not mentioned herein for the sake of brevity. As such, the above configurations are illustrative, and should not be construed as being limited in any way. According to various implementations, the social networking services 1622 may host one or more applications and/or software modules for providing the functionality described herein for providing contextually-aware insights into email messages. For instance, any one of the application servers 1608 may communicate or facilitate the functionality and features described herein. For instance, a social networking application, mail client, messaging client or a browser running on a phone or any other client 1606 may communicate with a networking service 1622 and facilitate the functionality, even in part, described above with respect to FIGS. 1-15.

As shown in FIG. 16, the application servers 1608 also can host other services, applications, portals, and/or other resources (“other resources”) 1624. The other resources 1624 can include, but are not limited to, document sharing, rendering or any other functionality. It thus can be appreciated that the computing environment 1602 can provide integration of the concepts and technologies disclosed herein provided herein with various mailbox, messaging, social networking, and/or other services or resources.

As mentioned above, the computing environment 1602 can include the data storage 1610. According to various implementations, the functionality of the data storage 1610 is provided by one or more databases operating on, or in communication with, the network 1604. The functionality of the data storage 1610 also can be provided by one or more server computers configured to host data for the computing environment 1602. The data storage 1610 can include, host, or provide one or more real or virtual data stores 1626A-1626N (hereinafter referred to collectively and/or generically as “datastores 1626”). The datastores 1626 are configured to host data used or created by the application servers 1608 and/or other data. Although not illustrated in FIG. 16, the datastores 1626 also can host or store web page documents, word documents, presentation documents, data structures, algorithms for execution by a recommendation engine, and/or other data utilized by any application program or another module. Aspects of the datastores 1626 may be associated with a service for storing files.

The computing environment 1602 can communicate with, or be accessed by, the network interfaces 1612. The network interfaces 1612 can include various types of network hardware and software for supporting communications between two or more computing devices including, but not limited to, the clients 1606 and the application servers 1608. It should be appreciated that the network interfaces 1612 also may be utilized to connect to other types of networks and/or computer systems.

It should be understood that the distributed computing environment 1600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1600 provides the software functionality described herein as a service to the clients 1606. It should be understood that the clients 1606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1600 to utilize the functionality described herein for providing contextually-aware insights into email messages, among other aspects.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should be also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Among many other technical benefits, the technologies herein enable more efficient use of computing resources such as processor cycles, memory, network bandwidth, and power, as compared to previous solutions relying upon inefficient manual placement of virtual objects in a 3D environment. Other technical benefits not specifically mentioned herein can also be realized through implementations of the disclosed subject matter.

Although the techniques have been described in language specific to structural features and/or methodological acts, it is to be understood that the appended claims are not necessarily limited to the features or acts described. Rather, the features and acts are described as example implementations of such techniques.

The disclosure presented herein also encompasses the subject matter set forth in the following clause:

A method to be performed by a data processing system, the method comprising: rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a summary of the new email message; wherein the summary is determined at least in part by a context of the new email message; inputting the prompt to the LLM; and
rendering, on the representation, the summary of the new email message.

The disclosure presented herein also encompasses the subject matter set forth in the following additional clauses:

Clause 1: A system comprising:
one or more data processing units; and
a computer-readable medium having encoded thereon computer-executable instructions to cause the one or more data processing units to perform operations comprising:
rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a priority of the new email message; wherein the priority is localized to a context based at least in part by a recipient and sender of the new email message;
inputting the prompt to the LLM;
receiving an output from the LLM indicating the determined priority; and
rendering, on the representation, the determined priority of the new email message.

Clause 2: The system of clause 1, wherein an event-based assistant (EBA) is invoked to cause the prompt to be generated.

Clause 3: The system of clauses 1 or 2, wherein the prompt is further usable to cause the LLM to analyze content of the new email message and generate a summary of contents of the new email message.

Clause 4: The system of any of clauses 1 through 3, wherein the instructions further cause the one or more data processing units to perform operations comprising:
rendering the summary within a message list view of the UI.

Clause 5: The system of any of clauses 1 through 4, wherein the summary is rendered in a subject line for the new email message as a micro-summary.

Clause 6: The system of any of clauses 1 through 5, wherein the instructions further cause the one or more data processing units to perform operations comprising:
providing an option to expand the micro-summary to a detailed summary.

Clause 7: The system of any of clauses 1 through 6, wherein the prompt is further usable to cause the LLM to provide a reason for the priority; wherein the instructions further cause the one or more data processing units to perform operations comprising:
rendering the reason on the UI.

Clause 8: The system of any of clauses 1 through 7, wherein the instructions further cause the one or more data processing units to perform operations comprising:
rendering, on the user interface, a window for providing user feedback pertaining to the determined priority.

Clause 9: The system of any of clauses 1 through 8, wherein the instructions further cause the one or more data processing units to perform operations comprising:
updating the determined priority based on contextual information for the user.

Clause 10: The system of any of clauses 1 through 9, wherein the instructions further cause the one or more data processing units to perform operations comprising:
in response to a user input, sorting messages in the message view based on the determined priority.

Clause 11: A method to be performed by a data processing system, the method comprising:
rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a priority of the new email message; wherein the priority is determined at least in part by a context of the new email message;
inputting the prompt to the LLM; and
rendering, on the representation, the priority of the new email message.

Clause 12: The method of clause 11, wherein an event-based assistant (EBA) is invoked to cause the prompt to be generated.

Clause 13: The method of any of clauses 11 and 12, wherein the prompt is further usable to cause the LLM to analyze content of the new email message and generate a summary of contents of the new email message.

Clause 14: The method of any clauses 11-13, further comprising rendering the summary within a message list view of the UI.

Clause 15: The method of any clauses 11-14, wherein the summary is rendered in a subject line for the new email message as a micro-summary.

Clause 16: The method of any clauses 11-15, further comprising providing an option to expand the micro-summary to a detailed summary.

Clause 17: The method of any clauses 11-16, wherein the prompt is further usable to cause the LLM to provide a reason for the priority.

Clause 18: The method of any clauses 11-17, further comprising rendering, on the user interface, a window for providing user feedback pertaining to the determined priority.

Clause 19: The method of any clauses 11-18, further comprising updating the determined priority based on contextual information for the user.

Clause 20: A computer-readable storage medium having computer-executable instructions stored thereupon which, when executed by one or more processors of a computing device, cause the computing device to perform operations comprising:
rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a priority of the new email message; wherein the priority is localized to a context based at least in part by a recipient and sender of the new email message;
inputting the prompt to the LLM;
receiving an output from the LLM indicating the determined priority; and
rendering, on the representation, the determined priority of the new email message.

What is claimed is:

1. A system comprising:
one or more processors; and
a computer-readable medium having encoded thereon computer-executable instructions to cause the one or more processors to perform operations comprising:
rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a priority of the new email message;
wherein the priority is localized to a context based at least in part by a recipient and sender of the new email message;
inputting the prompt to the LLM;
receiving an output from the LLM indicating the determined priority; and
rendering, on the representation, the determined priority of the new email message.

2. The system of claim 1, wherein an event-based assistant (EBA) is invoked to cause the prompt to be generated.

3. The system of claim 1, wherein the prompt is further usable to cause the LLM to analyze content of the new email message and generate a summary of contents of the new email message.

4. The system of claim 3, wherein the instructions further cause the one or more processors to perform operations comprising:
rendering the summary within a message list view of the UI.

5. The system of claim 4, wherein the summary is rendered in a subject line for the new email message as a micro-summary.

6. The system of claim 5, wherein the instructions further cause the one or more processors to perform operations comprising:
providing an option to expand the micro-summary to a detailed summary.

7. The system of claim 1, wherein the prompt is further usable to cause the LLM to provide a reason for the priority; wherein the instructions further cause the one or more processors to perform operations comprising:
rendering the reason on the UI.

8. The system of claim 1, wherein the instructions further cause the one or more processors to perform operations comprising:
rendering, on the user interface, a window for providing user feedback pertaining to the determined priority.

9. The system of claim 1, wherein the instructions further cause the one or more processors to perform operations comprising:
updating the determined priority based on contextual information for the user.

10. The system of claim 1, wherein the instructions further cause the one or more processors to perform operations comprising:
in response to a user input, sorting messages in the message view based on the determined priority.

11. A method to be performed by a data processing system, the method comprising:
rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a priority of the new email message;
wherein the priority is determined at least in part by a context of the new email message;
inputting the prompt to the LLM; and
rendering, on the representation, the priority of the new email message.

12. The method of claim 11, wherein an event-based assistant (EBA) is invoked to cause the prompt to be generated.

13. The method of claim 11, wherein the prompt is further usable to cause the LLM to analyze content of the new email message and generate a summary of contents of the new email message.

14. The method of claim 13, further comprising rendering the summary within a message list view of the UI.

15. The method of claim 14, wherein the summary is rendered in a subject line for the new email message as a micro-summary.

16. The method of claim 15, further comprising providing an option to expand the micro-summary to a detailed summary.

17. The method of claim 11, wherein the prompt is further usable to cause the LLM to provide a reason for the priority.

18. The method of claim 11, further comprising rendering, on the user interface, a window for providing user feedback pertaining to the determined priority.

19. The method of claim 11, further comprising updating the determined priority based on contextual information for the user.

20. A computer-readable storage medium having computer-executable instructions stored thereupon which, when executed by one or more processors of a computing device, cause the computing device to perform operations comprising:
rendering a representation of an email application on a user interface (UI), the representation including at least one email message or a message view comprising a plurality of email messages;
receiving an indication that a new email message has been received;
in response to receiving the indication, dynamically generating a prompt for input to a large language model (LLM), wherein the prompt is usable to cause the LLM to analyze content of the new email message and determine a priority of the new email message;
wherein the priority is localized to a context based at least in part by a recipient and sender of the new email message;
inputting the prompt to the LLM;
receiving an output from the LLM indicating the determined priority; and
rendering, on the representation, the determined priority of the new email message.
